(19) United States
(12) Patent Application Publication
(10) Pub. No.: US 2009/0084031 A1
(43) Pub. Date: Apr. 2, 2009

(54) Control of noxious weeds using enhanced seed germination

(76) Inventors: Pamela Sue Smith, Dallas, TX (US); Craig Ralph Young, Dallas, TX (US)

Correspondence Address: Pamela S. Smith, 4039 Holland Ave., Dallas, TX, 75219, US

(21) Appl. No.: 11/906,282

(22) Filed: Oct. 1, 2007

(51) Int. Cl. A01N 25/00; A01N 25/16

(52) U.S. Cl. 47/32.3

(57) ABSTRACT

A method of controlling noxious weeds comprising removing the noxious weed, encouraging the germination of the seed remaining after removal of the plant, covering the area containing the seed until the seed germinates into a seedling, allowing the seedling to die under the cover then removing the cover either physically or by incorporating it into the soil.

### TECHNICAL FIELD

This description relates to controlling the propagation of noxious weeds, more particularly by enhancing the germination of the weed's seed, then killing the sprouted seedling.

### BACKGROUND

One of the challenges facing agriculture is noxious weed invasion. Noxious weeds are estimated to cost the economy over $4 billion dollars per year. Frequently these weeds are non-native plants introduced either inadvertently or for a purpose but then which subsequently grew at an unmanageable rate, overwhelming native species and disrupting the eco-system. Examples of such noxious weeds include kudzu, mimosa, mesquite and gorse. This description focuses on particular implementation having to do with gorse but the invention can clearly be used in the control of other noxious weeds.

Gorse (also known as Irish Furze) was introduced to the US Pacific Northwest, New Zealand, Hi. and other temperate climates from its native central and Western Europe with disastrous results. Gorse grows and spreads quickly, creating a thorny, impenetrably dense undergrowth. It can grow in sand or heavy clay soil but prefers acid soil in the range of pH 4-5. Native plants are displaced and local wildlife is left without food. Because of the oil content of the bush, a stand of gorse is also a fire hazard with the result that fire stimulates seedling growth, continuing and exacerbating the problem. Gorse alone is estimated to have made 23 million hectares of land unusable.

The gorse plants produce prodigious numbers of seed (500-600 per meter) in as few as 18 months, often seeding twice per year. The seeds can remain viable for long periods of time. The seeds are 10-20 mm long and 6 cm wide, contained in oblong hairy pods. Gorse plants typically scatter seeds, propelling them up to several meters during hot weather. The seeds have a hard coating that delays germination. Germination has been found to be encouraged by heat, abrasion and treatment with acid. Current methods of gorse control include a combination of herbicides, burning, mechanical removal and establishing competing species.

Cost of control is typically quite expensive and labor intensive, requiring repeated applications of herbicides. Control programs require strict adherence to a five year regimen. If the plant is chopped down, new plants emerge from the stump. The seeds begin to sprout, leaving the farmer worse off than before treatment. Burning seems to enhance regrowth. Some biological agents have been introduced (gorse thrips, gorse spider mites), but to date no effective biological treatment has been demonstrated It is clear that a new, ecologically friendly approach to noxious weed control is needed that attacks the seeds remaining after destruction of the plants.

### SUMMARY

It is clear that mechanical destruction of noxious plants producing copious numbers of seed simply exacerbates the problem. Herbicides can be used to control the new plants but the application must be regular, at great expense and with accompanying possible ecological damage. The method for controlling noxious weeds set forth herein is targeted at the seeds rather than at the plant itself. After removal of the plant, the seeds! are covered for a period with a semi-permeable or impermeable coating, foam or mat that allows water and abrasion from the mat to encourage germination. The ambient heat also encourages the seedling to emerge. Once the seed coating is breached and the germination begun, the seedling will quickly die when there is no light or room for it to grow. The seed cannot regerminate and is no longer capable of spreading the noxious weed.

The options presented in the present invention include other ways to encourage germination; burning the noxious plant stand if the operation can be safely performed, acidifying the soil, adding chemical fertilizers to the soil, using other germination enhancing chemicals commonly found in agricultural use and using conventional farming techniques such as harrowing or tilling the soil to abrade the seed.

After encouraging the germination of the seed using one or more methods outlined above the seed-containing area is covered with a mat, foam or cover. If the soil is not thoroughly soaked, then the cover must allow water to reach the seeds for germination. There are several biodegradable mats that would be suitable for covering the treated area. Foams and spray-on coatings are also within the scope of the invention.

The details of one or more implementations are set forth in the accompanying drawings and description below. Other features will be apparent from the description and drawings and from the claims.

### DESCRIPTION OF DRAWINGS

FIG. 1 is an illustration of a stand of noxious weeds.

FIG. 2 is an illustration of land after the noxious weeds cut down to ground level.

FIG. 3 is an illustration of a side view of soil, noxious weed seeds and plant detritus.

FIG. 4 is an illustration of land with plant detritus covered with a mat.

FIG. 5 is an illustration of land furrowed, abrading the noxious weed seeds near the surface.

FIG. 6 is an illustration of an application of germination enhancing chemical.

FIG. 7 is an illustration of a semi-permeable mat covering the soil and noxious weed seeds.

FIG. 8 is an illustration of the application of the mat by means of a spray.

### DETAILED DESCRIPTION

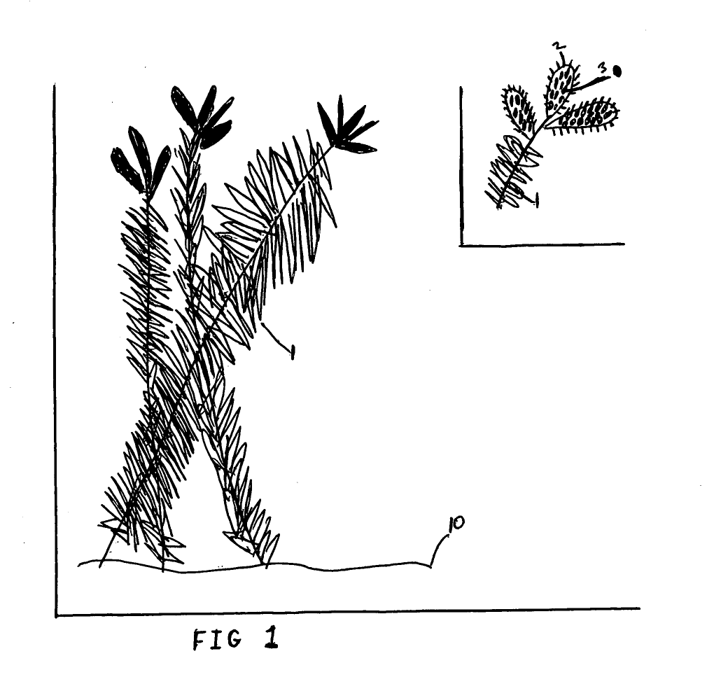

Gorse and other noxious seeds can be incredibly invasive and costly to the farmer in terms of lost productivity and in cost of control of the plant. Although the description below will focus by way of example on gorse, it should be understood that the techniques will be applicable to many other noxious plants that spread by copious seed-bearing. FIG. 1 is a plot of land 10 containing a stand of gorse plant 1. A gorse plant 1 grows to about 1-2.5 m in height with thorns covering the stems and branches. The interior branches of the gorse plant 1 tend to die and create a fire hazard. The inset of FIG. 1 shows 2 the oblong hairy pod containing 3 the smooth, round seed.

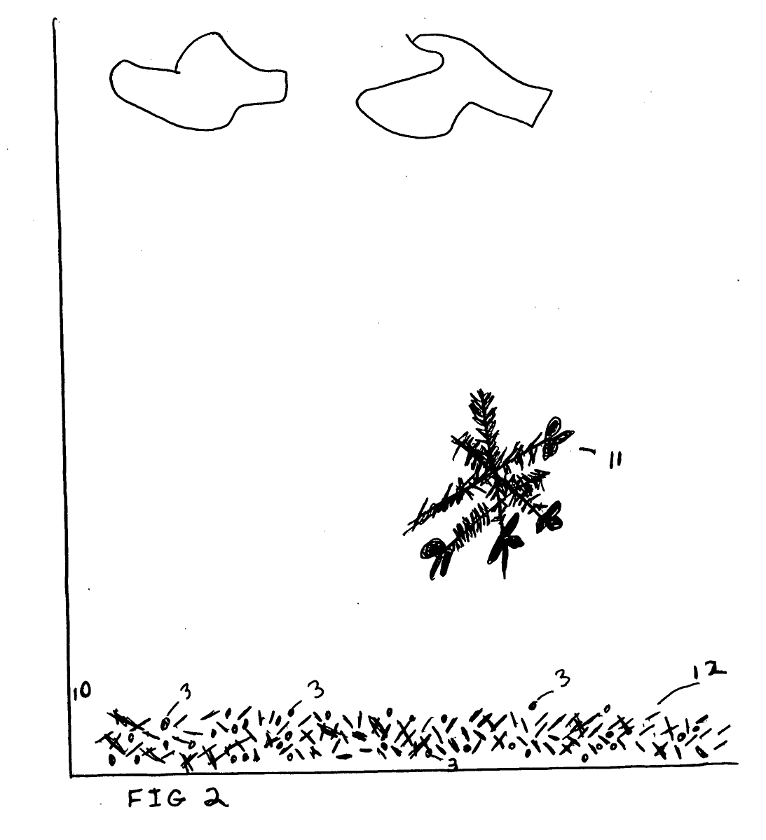

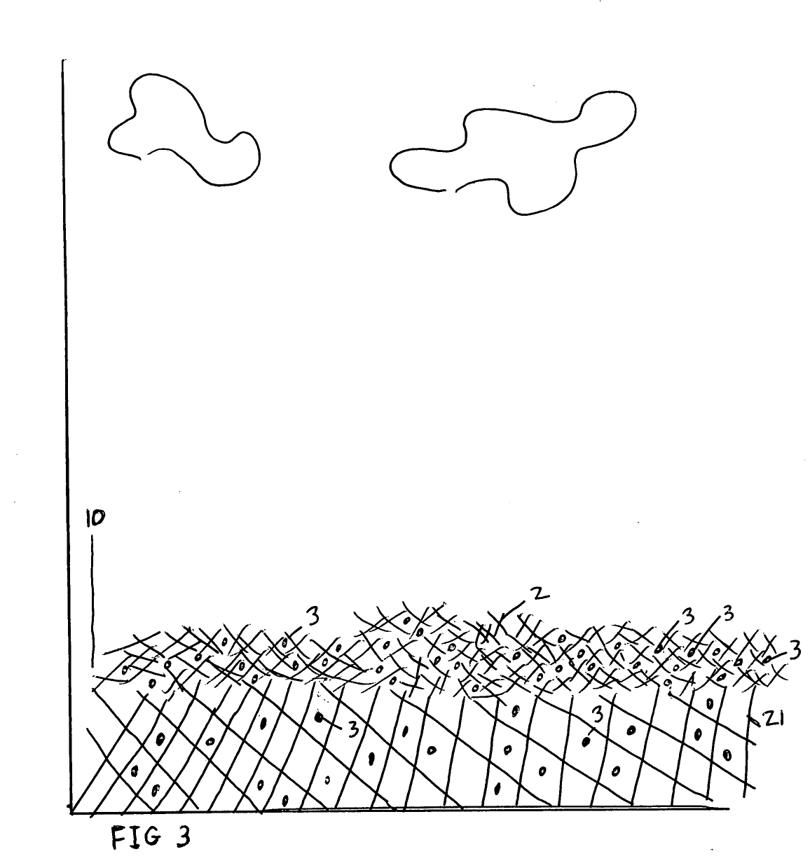

FIG. 2 shows the plot of land 10 after the gorse has been cleared by mechanical means such a with a chain saw, chain or with a tractor blade. The removed plants 11 may ether be hauled away or burned in place. No. 12 shows a carpet of needles, seeds and twigs left after the removal of the plants. FIG. 3 is a cut-way of the cleared plot 10 showing soil 21, plant detritus 2 and seeds 3.

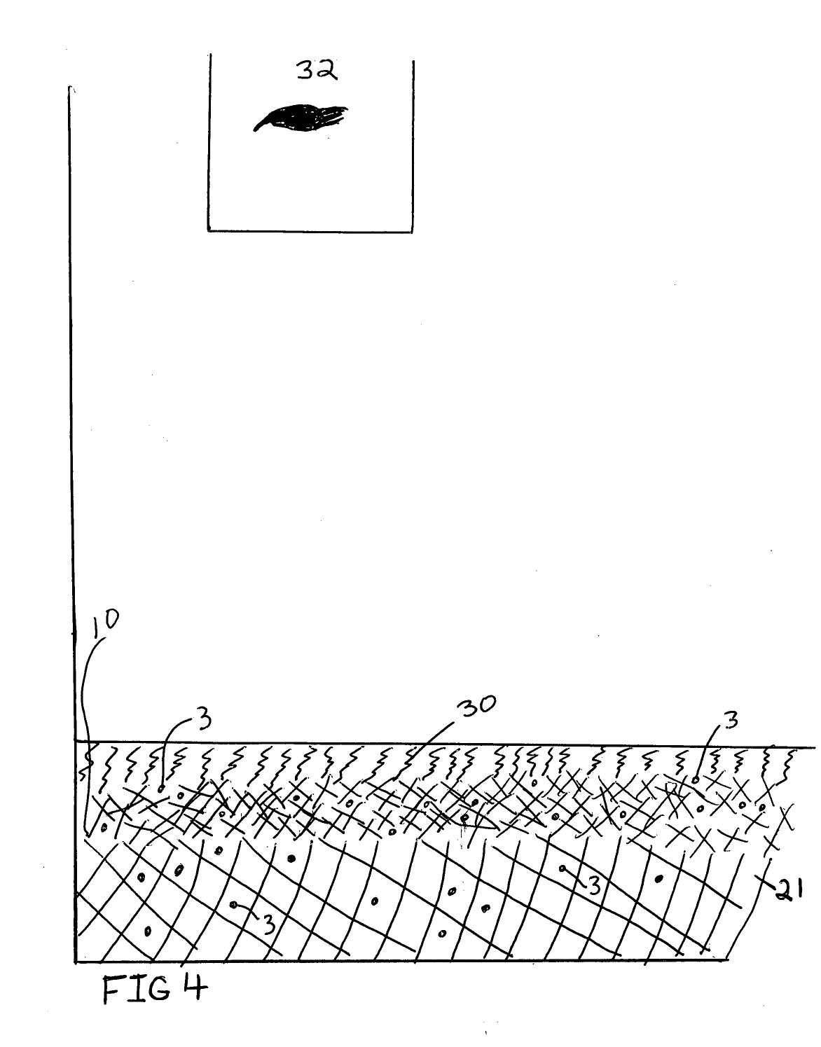

In one implementation of the invention, FIG. 4 the plot of land 10 is covered with a semi-permeable mat 30 and the mat is allowed to remain in place for 3 wks-12 months. The mat may be opaque or dark in color to absorb sun so as to encourage germination. Rain seeps through the mat to provide moisture to the seeds 3 and the warms the soil underneath. An example of such a mat is described in U.S. Pat. No. 5,853,541 which also has the advantage of being biodegradable. The covered seeds 3 gradually sprout into seedlings 32 having rudimentry leaves and roots. The seedlings find insufficient light or means of taking root and thus die. When in FIG. 4 the mat 30 is removed after a pre-determined effective time, the area is either free of gorse or has a much reduced population. In another manifestation the mat may be biodegradable and simply plowed into the soil 21.

In another variation the plot of land 10 is soaked with water where the cover 30 is impermeable. The water will allow the seeds 3 to germinate in a highly humid environment and rot after sprouting.

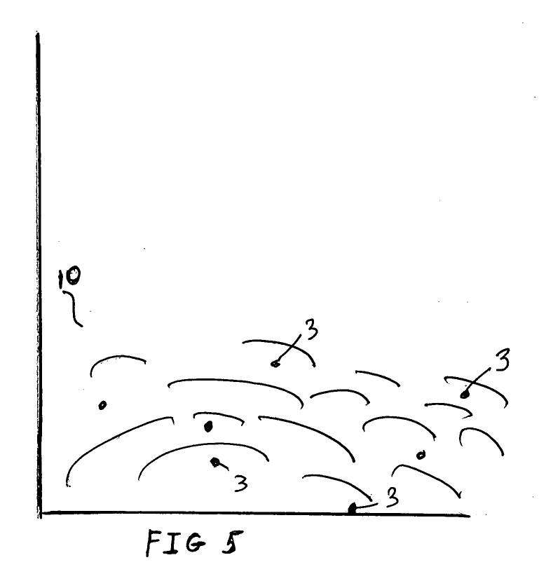

In another implementation of the invention the plot 10 is harrowed or tilled as is common in farming practice as FIG. 5. The seeds 3 are abraded by the mechanical tool and the soil itself. This abrasion encourages seed germination by damaging the seed's protective coating.

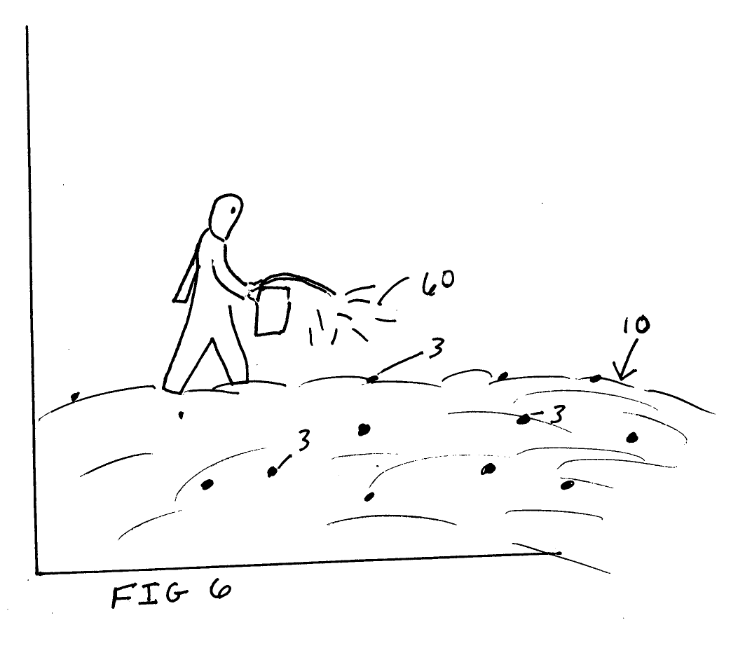

In yet another manifestation of the invention, FIG. 6 the plot 10 is treated with chemicals such as an acid solution 60 (for example acetic acid or vinegar), a commercially available germination enhancer such those described in U.S. Pat. Nos. 7,192,523; 6,979,664,7,189,889; or 7,022,648 or a fertilizer solution. There chemicals which also encourage the seeds 3 to germinate by softening the outer protective coating of the seed.

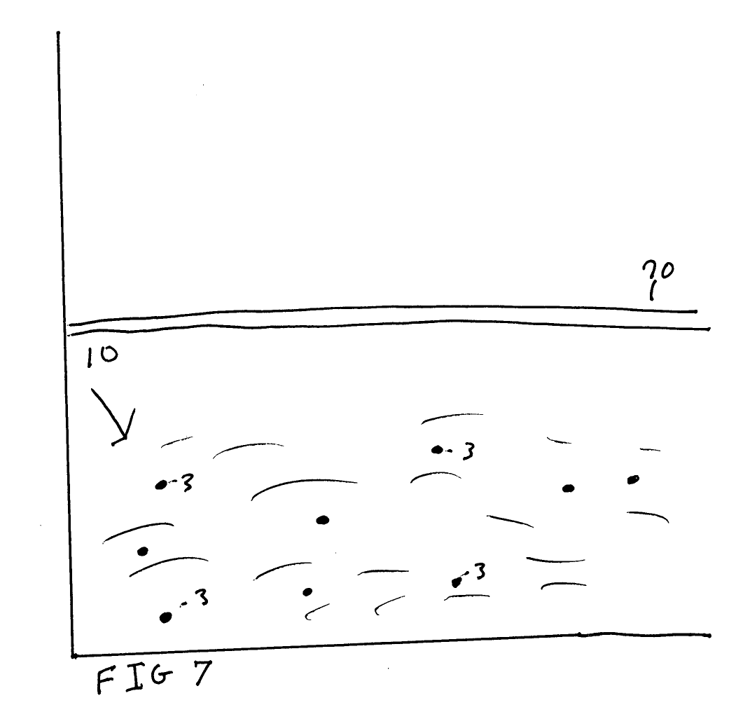

In FIG. 4 a semi-permeable mat is used to cover the seed ridden ground. In FIG.7 the plot 10 is treated as above to encourage seed germination, then a coating 70 placed over the plot 10 containing the seeds 3. One such cover, by way of example it set out in United States patent Application Number 20060160922 dated Jul. 20, 2006. The biodegradable polymer film could be used as a cover for several months then plowed under without fouling agricultural machinery.

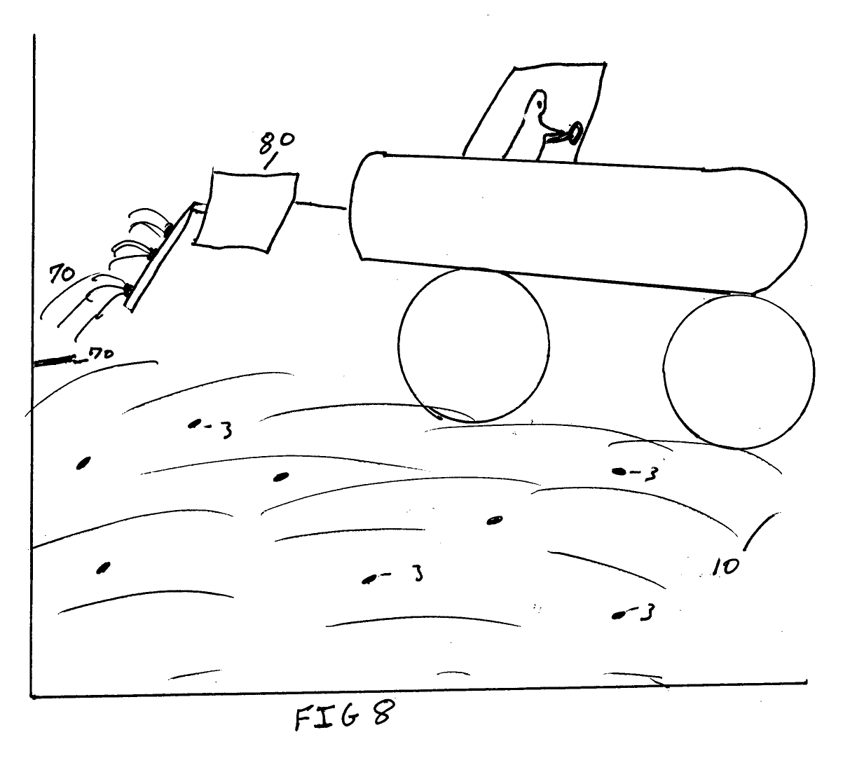

In FIG. 8 yet another variation of the invention is described wherein a coating 70 is applied to the treated plot 10 by way of a sprayer 80. While FIG.8 shows a manually applied spraying means, it should be understood that the spraying can also be accomplished by a power sprayer as is common in agricultural use or by airplane. Examples of possible spray coatings include U.S. Pat. Nos. 6,686,414 and 6,270,291.

A number of variations of the invention have been described. Nevertheless, it should be understood that the steps may be performed in different orders or in combinations. Accordingly, other implementations are within the scope of the following claims.

What is claimed is:

1. A process for controlling seed bearing invasive plants comprising:
clearing an area of invasive plants;
encouraging germination of the invasive plants' seeds remaining in or on top of the soil after clearing;
enveloping the cleared area with a cover;
leaving the cover in place until seed germination has occurred;
allowing a seedling emerging from the seed to die under the cover; and
removing the cover after the seedlings are dead.

2. The process of 1 wherein the clearing is accomplished by removing the plants by farm machinery.

3. The process of 1 wherein the clearing is accomplished by burning.

4. The process of 1 wherein the germination of the seed is encouraged by adding a chemical germination enhancer.

5. The process of 1 wherein the germination of the seed is encouraged by abrading the seed.

6. The process of 1 wherein the germination of the seed is encouraged by altering the pH of the soil.

7. The process of 1 wherein the cover is a mat.

8. The process of 1 wherein the cover is a spray on polymeric dispersion.

9. The process of 8 wherein the polymeric dispersion forms a solid crust cover upon curing.

10. The process of 1 wherein the cover is a foam.

11. The process of 1 wherein the cover is biodegradable.

12. The process of 1 wherein the cover is opaque.

13. The process of 1 wherein the cover is semi-permeable to water.

14. The process of 1 wherein the cover is incorporated into the soil during step e)

15. A process for controlling invasive plants comprising:
clearing an area of seed bearing invasive plants;
encouraging germination of invasive plant seeds by abrading the seed by means of turning soil containing the seed with a soil tilling implement;
spraying the cleared area with a polymeric dispersion;
allowing the polymeric dispersion to cure to form a cover;
leaving the cover in place until a substantial portion of the seeds have germinated;
allowing a seedling emerging from the seed to die; and
incorporating the cover into the soil by plowing.

16. The process of 15 wherein germination is further encouraged by adding a chemical germination enhancer to the water.

17. The process of 15 wherein germination is further encouraged by adjusting the pH of the soil.

18. The of process 15 wherein the semi-permeable cover is biodegradable.

19. The process of 15 wherein the cover is opaque.

20. A process for controlling seed-bearing invasive plants comprising
a. clearing an area of seed bearing invasive plants;
b. encouraging germination of the seeds by abrading said seeds;
c. treating the area containing the seeds with a water solution of a chemical germination enhancer;
d. spraying the cleared area with a biodegradable foam;
e. leaving the foam in place until seeds have germinated;
f. allowing seedling to emerge from the seed;
g. leaving the foam in place until the seedlings have died.

21. The process of 20 wherein the foam is incorporated into the soil after step e.

22. The process of 20 wherein the foam is semi-permeable to water..

23. The process of 20 wherein step c includes adjusting the pH of the water solution.

24. A process for controlling seed-bearing invasive plants comprising:
clearing an area of seed bearing invasive plants;
placing a mat over soil in the area containing seed, the mat comprising a substrate in contact with the soil, the substrate containing a seed germination enhancer, the substrate being immediately adjacent to a fibrous layer.
leaving the mat in place until the seeds have germinated;
allowing seedlings to emerge from the seed leaving the mat in place until the seedlings have died.

25. The process of 24 wherein the fibrous layer is biodegradable.
